(19) United States
(12) Patent Application Publication
(10) Pub. No.: US 2002/0025747 A1
(43) Pub. Date: Feb. 28, 2002

(54) Windproof and water resistant composite fabric

(76) Inventors: Moshe Rock, Andover, MA (US); Vikram Sharma, Stoneham, MA (US)

Correspondence Address: Jeffrey M. Kaden, Esq., Gottlieb, Rackman & Reisman, P.C., 270 Madison Avenue, New York, NY, 10016-0601, US

(21) Appl. No.: 09/863,852

(22) Filed: May 23, 2001

Related U.S. Application Data
(63) Continuation of application No. 09/378,344, filed on Aug. 20, 1999.

(51) Int. Cl. B32B 3/00

(52) U.S. Cl. 442/59; 156/229

(57) ABSTRACT

A wind resistant and water vapor permeable composite fabric is provided. The composite fabric includes an inner fabric layer, an outer fabric layer, and an intermediate vapor barrier. The vapor barrier may be selected from an adhesive material or an adhesive/membrane combination that is designed so that the fabric has a variable water vapor diffusion resistance which substantially decreases as air speed impinging on the fabric increases.

### BACKGROUND OF THE INVENTION

This invention relates to a fabric material, and more particularly, to a composite fabric having controlled wind permeability. This application is a continuation of Provisional Application Ser. No. 60/098254 filed Aug. 28, 1998.

Conventional composite fabrics are designed to be fully wind resistant. By way of example, reference is made to U.S. Pat. Nos. 5,204,156; 5,268,212; and 5,364,678, all entitled “Windproof and Water Resistant Composite Fabric With Barrier Layer,” and which describe a drapable, stretchable windproof, water resistant and water-permeable composite fabric. This composite fabric includes an inner fabric layer 13A, an outer fabric layer 13B, and a barrier or membrane layer 17A (see FIG. 1). The barrier or membrane layer is constructed to prevent air and water from passing through the fabric layers. Testing has shown that the amount of air flowing through such a composite fabric is on the order or no more than 1 ft.³/ft.²/min.

The membrane or barrier of this type of prior art fabric composite is typically adhered or bonded to the fabric layers with the aid of an adhesive 18A. The adhesive can be made from a polyurethane, polyester, acrylic or polyamide. Reference is made to FIG. 1, which illustrates the composite fabric of the prior art.

The above-described fabric composite is nonetheless less than desirable. Because such a composite fabric allows only minimal air flow therethrough, the wearer-of the fabric may not be comfortable. When a person wearing a garment constructed with the composite fabric of the prior art performs some type of physical activity, heat is almost always generated, even if the outside air is cold. In order to adjust for this heat generation, the two fabric layers may be selected to have low insulative properties. However, this is disadvantageous, since using such a fabric composite will cause the wearer to feel cold when no activity is being performed.

Another disadvantage with prior art composite fabrics is the level of moisture vapor transmission. For example, a membrane made of polytetrafluroethylene, while having a higher moisture vapor transmission performance than a polyurethane membrane, is still not desirable, since it cannot handle a situation where high levels of moisture vapor or sweat are generated. As a result, wearer discomfort is often prevalent, due to this limitation on moisture transport. Specifically, excess moisture which could not be transported out from the fabric condenses next to the skin-side surface, producing a cold feeling on the skin of the person wearing a garment made from this type of prior art composite fabric.

Accordingly, it is desirable to provide an improved windproof, water vapor permeable fabric which eliminates the problems associated with prior art fabrics.

### SUMMARY OF THE INVENTION

Generally speaking, in accordance with the invention, a wind resistant and water vapor permeable composite fabric is provided. The composite fabric includes an inner fabric layer, an outer fabric layer, and an intermediate vapor barrier. The vapor barrier may be selected from an adhesive material or an adhesive/membrane combination that is designed so that the fabric has a variable moisture/vapor diffusion resistance which substantially decreases as air speed impinging on the fabric increases.

The adhesive may be a continuous film which is mechanically altered by means of crushing, stretching and the like to enhance air permeability or a discontinuous film which inherently enhances air permeability. The adhesive and/or the membrane may be applied directly to a fabric surface of one or both of the fabric layers or may be applied by means of transfer coating from release paper.

In one example, the adhesive functions as a vapor barrier and is disposed between the two fabric layers. The adhesive may be in the form of a foam. One or more rollers may be used to apply pressure to the fabric in order to selectively adjust the air permeability characteristics thereof.

In a second embodiment, the vapor barrier comprises a membrane made from polyurethane, polyamide, polytetrafluroethylene or polyester, or a combination thereof, which is applied between the two fabric layers and adhered thereto with an adhesive. The fabric composite undergoes mechanical processing, such as controlled stretching, in order to achieve a desired level of air permeability.

Accordingly, it is an object of the invention to provide an improved windproof composite fabric.

Still another object of the invention is to provide a composite fabric which is water resistant.

A further object of the invention is to provide a composite fabric whose wind resistance may be varied.

Yet another object of the invention is to provide a composite fabric having a moisture vapor transmission rate which substantially increases as air speed impinging on the fabric increases.

Still other objects and advantages of the invention will in part be obvious and will in part be apparent from the following description.

The invention accordingly comprises the several steps and the relation of one or more steps with respect to each of the others, and the fabric possessing the features, properties and construction of elements which are exemplified in the following detailed disclosure, and the scope of the invention is indicated in the claims.

### BRIEF DESCRIPTION OF THE DRAWINGS

For a fuller understanding of the invention, reference is made to the following description, taken in connection with the accompanying drawings, in which:

FIG. 1 is a front view in cross-section illustrating a composite fabric of the prior art;

FIG. 2 is a front view in cross-section illustrating a composite fabric made in accordance with the invention;

FIG. 3A is a graph which shows the change in moisture vapor transmission as a function of air permeability in the inventive composite fabric;

FIG. 3B is a graph showing the change in air permeability as a function of thermal resistance in the inventive composite fabric;

FIG. 4A is a front view in cross-section showing formation of a second embodiment of the composite fabric of the invention;

FIG. 4B shows the effects of controlled stretching on the composite fabric depicted in FIG. 4A;

FIG. 5 is a front view in cross-section showing the formation of a third embodiment of the inventive composite fabric;

FIG. 6 is a front elevational view in cross-section showing the formation of a fourth embodiment of the inventive composite fabric; and

FIG. 7 is a graph showing the relationship of water vapor resistance as a function of wind speed impinging on the inventive fabric as compared to prior art fabrics.

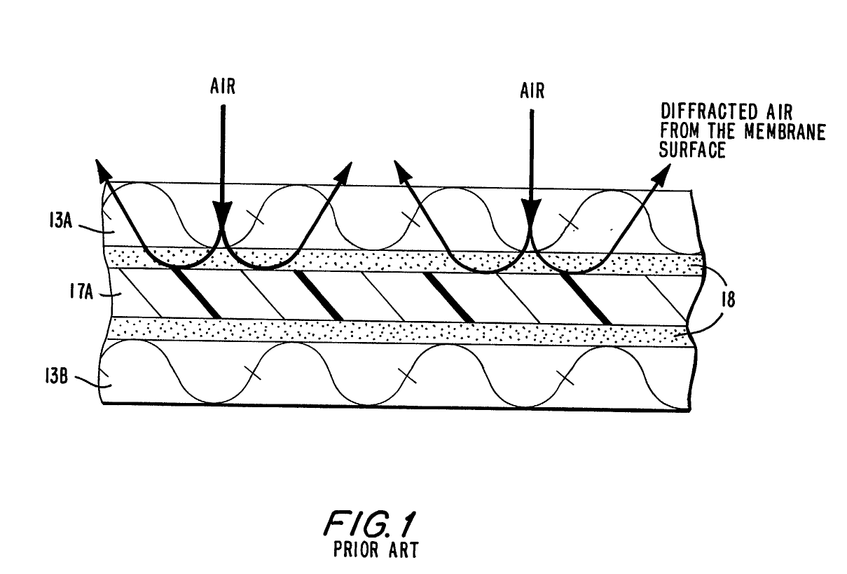

### BRIEF DESCRIPTION OF THE DRAWINGS

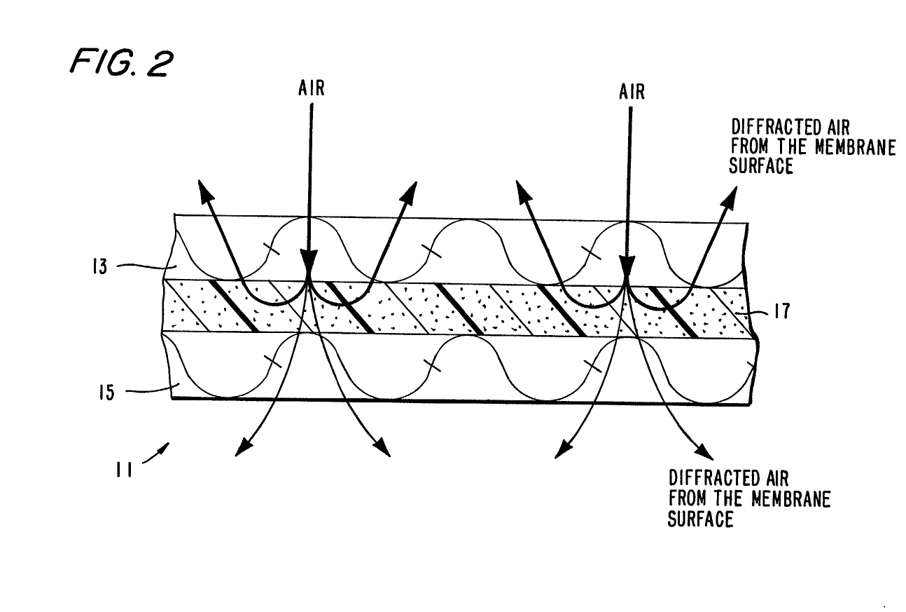

Referring first to FIG. 2, a first embodiment of the inventive composite fabric, generally indicated at 11, is shown. Fabric 11 comprises first and second fabric layers 13 and 15, and a barrier 17 disposed therebetween. Fabric 11 has a variable water vapor permeability, as discussed below. In this embodiment, the barrier 17 consists of an adhesive material. Adhesive 17 may, in one form, be applied by means of transfer coating from release paper at between 0.25 oz/yd² and 2.5 oz/yd². Each of layers 13 and 15 may be treated or modified, as described in U.S. Pat. Nos. 5,204,156; 5,268,212; and 5,364,678, including rendering the layers hydrophilic, providing the layers with a raised surface, treating the layers to be water repellant, etc.

Fabric 11 is formed to any specific controlled wind resistant performance level, as discussed below. As shown, air which impinges upon fabric 11 is partially deflected away from the barrier 17 and partially penetrates as well through the barrier 17.

In the absence of moving air, water vapor/moisture from the skin can only transfer through the fabric by means of an absorption/adsorption phenomenon leading to excess heat buildup and moisture. When fabric allows some air to pass through the barrier, it helps in transferring high moisture levels and thus make the wearer more comfortable.

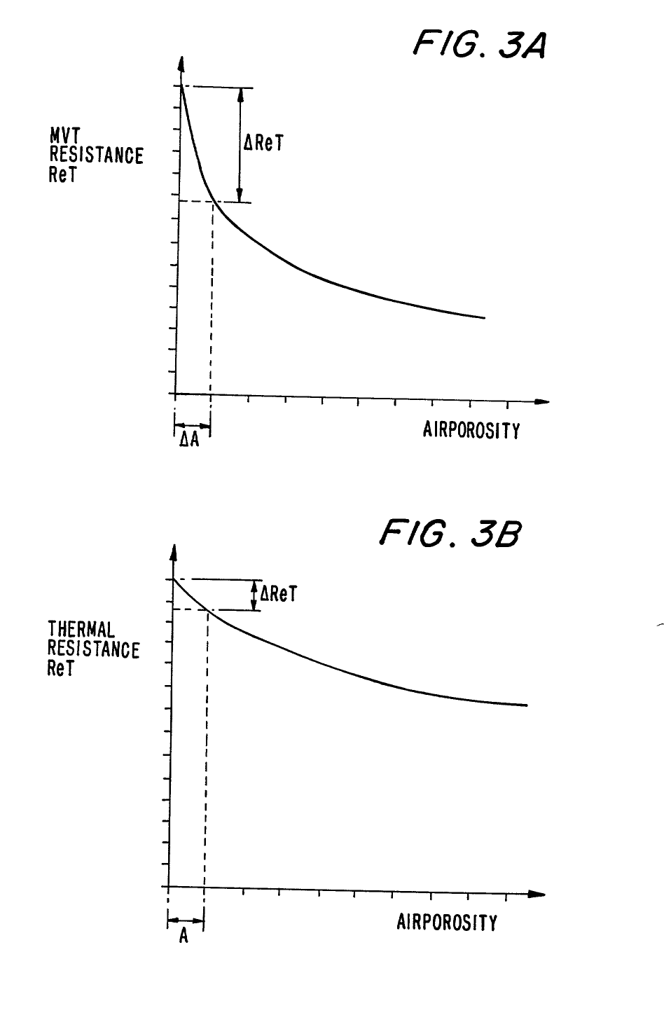

Importantly, as wind speed increases, more air flows through the barrier, allowing more vapor to be dissipated. Thus, the composite fabric of the invention has a relatively high water vapor permeability in moving air, and has substantially reduced resistance to vapor permeability with an increase in air flow. The reduction in wind resistance or increase in air permeability will not cause any significant loss of the thermal insulative properties, as shown in the graphs of FIG. 3A and 3B now discussed, because the actual amount of air penetrating the barrier is minimal.

The graph of FIG. 3A illustrates that for any increase in air permeability of the inventive fabric, there is a corresponding decrease in evaporation pressure resistance. The graph of FIG. 3B shows that for any increase in air permeability of the inventive fabric, there will be a corresponding decrease in thermal resistance of the composite fabric. As can be appreciated from reviewing the graphs, there is a substantial difference between the magnitude of change in evaporation pressure resistance and thermal resistance. Evaporation pressure resistance drops far more rapidly than thermal resistance for the same amount of change in air permeability of the composite fabric. Thus, when there is a small increase in air permeability of the composite fabric, the evaporative pressure resistance reduces significantly. As evaporation pressure resistance decreases, more moisture can be transported across the composite fabric, and thus, the loss in thermal resistance which defines the warmth of the fabric is not affected significantly.

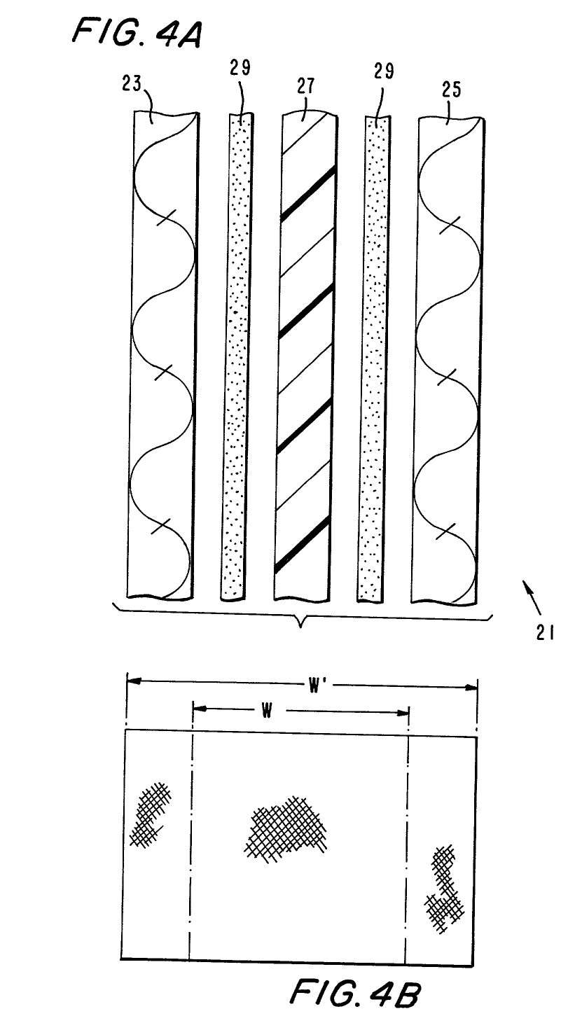

FIG. 4A describes a second embodiment of the inventive composite fabric, which is generally indicated at 21. Composite fabric 21 includes first and second fabric layers 23 and 25, a barrier which in this case is an intermediate membrane 27, and an adhesive 29 on either side of membrane 27 for adhering membrane 27 to fabric layers 23 and 25. Adhesive 29 may, in one form, be applied by means of transfer coating from release paper at a thickness of between 0.25 oz/yd² and 2.5 oz/yd². Membrane 27 is made from polyurethane, polytetrafluroethyelene or polyester. Membrane 27 may be applied by means of transfer coating from release paper at a thickness of between 0.0001 in. and 0.010 in., or directly on the fabric surfaces at a thickness of between 0.0003 in. and 0.010 in.

As shown in FIG. 4B, composite fabric 21 is subjected to controlled stretching to produce a composite with a desired specific level of air permeability.

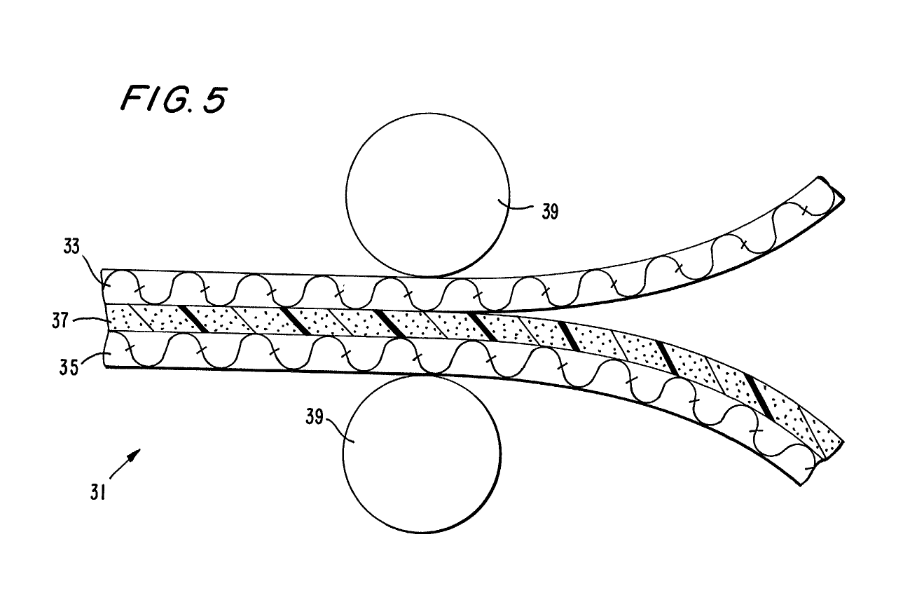

Referring now to FIG. 5, a third embodiment of the inventive composite fabric is shown and generally indicated at 31. Composite fabric 31 includes fabric layers 33 and 35, and a barrier consisting of an intermediate adhesive 37. The adhesive is chosen from a polyurethane, polyester, acrylic or polyamide. Here, adhesive 37 is applied as a foam at between about 0.3 oz/yd² and 10 oz/yd². The foam density (mixing air with adhesive) and the amount of adhesive applied are selected depending on the desired air permeability of the composite. Composite fabric 31 is prepared by first applying foam adhesive 37 on one of the surfaces of fabric layers 23 or 25. Once applied, the other fabric layer is put over the adhesive in order to produce the inventive fabric composite. Composite 31 is then mechanically processed by means of a pair of rollers 39, which apply pressure thereto in an amount between about 10 lbs./in.² and 150 lbs/in.² in order to produce a composite having a specific level of air permeability.

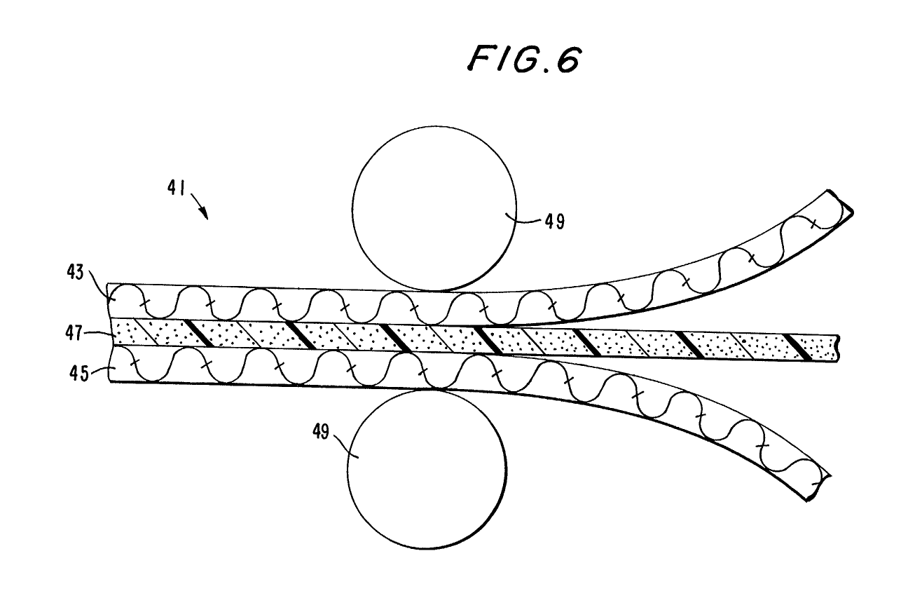

Referring now to FIG. 6, a further embodiment of the inventive composite fabric is shown. Composite fabric 41 comprises fabric layers 43 and 45 and a barrier formed of an intermediate adhesive 47. Air permeability is controlled by applying the adhesive on the fabric and then using some type of mechanical processing, such as treatment with rollers 19, in order to create the desired levels of air permeability.

Still referring to FIG. 6, adhesive 47 may, in one form, be applied by means of a release paper. The adhesive is first placed on the release paper at between about 0.25 oz./yd.² and 2.5 o.z./yd.², after which one of the fabric layers is put on top thereof in order for bonding to occur. Then, the release paper is stripped from the fabric and the second fabric layer is applied to the other side of the adhesive. The composite then undergoes mechanical processing by rollers 49 (which may be heated to a temperature of between about 100° F. and 375° F.), which apply pressure to the composite fabric. As can be appreciated, changing any mechanical parameter (roller temperature, pressure applied and speed of the fabric through the rollers) helps change the air permeability characteristics of the composite fabric.

Alternatively, and still referring to FIG. 6, adhesive 47 may be applied directly to one of fabric layers 43 and 45 (at 0.25 oz./yd.² to 2.5 oz./yd.²) without the use of release paper. As before, the composite fabric will undergo mechanical processing in order to achieve a desired air permeability performance.

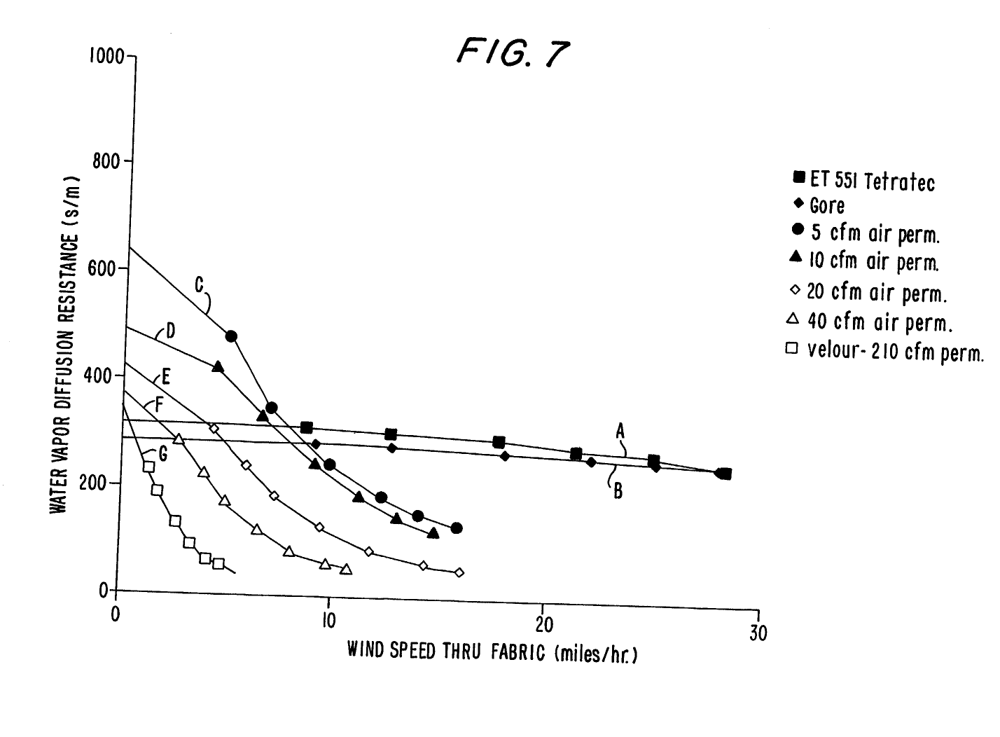

FIG. 7 describes the advantages of the present invention over the prior art. In this figure, lines A and B show the water vapor diffusion resistance for two prior art fabrics (Gore Windstopper using Goretex PTFE membrane and ETS51 laminate made with Tetratec PTFE). As seen in FIG. 7, the diffusion resistance for these prior art fabrics is substantially constant. However, in the materials identified by lines C, D, E and F, corresponding respectively to various air permeability level samples (high to low), the vapor diffusion resistance decreases dramatically with increased wind speed through the fabric.

It will thus be seen that the objects set forth above, among those made apparent from the preceding description, are efficiently attained, and, since certain changes may be made in carrying out the above method and in the fabric construction set forth without departing from the spirit and scope of the invention, it is intended that all matter contained in the above description and shown in the drawings shall be interpreted as merely illustrative, and should not be considered limiting.

The following claims are intended to cover all of the generic and specific features of the invention described herein, and all statements of the scope of the invention which might be said to fall therebetween.

1. A composite fabric comprising first and second fabric layers and an intermediate vapor barrier having a variable water vapor diffusion resistance which substantially decreases as air speed impinging on said fabric increases.

2. The composite fabric of claim 1, wherein said vapor barrier comprises a membrane made from a material selected from the group consisting of polyurethane, polyamide, polytetrafluroethylene, polyester, or a combination thereof.

3. The composite fabric of claim 2, having the characteristics of said membrane being controllably stretchable.

4. The composite fabric of claim 1, wherein said vapor barrier comprises an adhesive.

5. The composite fabric of claim 4, wherein said adhesive is foamed.

6. The composite fabric of claim 4, wherein said adhesive is selected from the group consisting of polyurethane, acrylics, polyamides, polyesters and combinations thereof.

7. The fabric of claim 1, wherein at least one of said fabric layers is rendered hydrophilic.

8. The fabric of claim 1, wherein at least one of said fabric layers has a raised surface.

9. The composite fabric of claim 1, wherein said barrier is a continuous layer.

10. The composite fabric of claim 1, wherein said adhesive is a discontinuous layer.

11. A method of forming a composite fabric comprising the steps of disposing a vapor barrier between a first and a second fabric layer in order to produce the fabric, said vapor barrier being selected from the group consisting of a membrane and an adhesive, and then mechanically processing the produced fabric such that water vapor diffusion resistance of the fabric decreases as air speed impinging on the fabric increases.

12. The method of claim 11, wherein said vapor barrier is a membrane, and wherein said mechanical processing comprises controlled stretching of the fabric.

13. The method of claim 11, wherein said vapor barrier is an adhesive and said mechanical processing comprises applying pressure to said fabric.

14. The method of claim 13, wherein pressure is applied by passing said fabric through a plurality of rollers.

15. The method of claim 14, wherein said rollers are heated.

16. The method of claim 13, wherein said fabric is passed through said rollers at variably controlled speeds.

17. The method of claim 13, wherein said adhesive is foamed.

18. The method of claim 13, wherein said adhesive is disposed between said layers by means of transfer coating by use of a release paper.

19. The method of claim 11, wherein said barrier is disposed between said fabric layers as a continuous film.

20. The method of claim 11, wherein said adhesive is disposed between said fabric layers as a discontinuous film.

21. The method of claim 11, wherein said barrier is disposed between said layers by means of a release paper.

22. The method of claim 11, wherein said barrier is disposed between said layers by application directly to at least one of said fabric layers.
